(19) United States
(12) Patent Application Publication
(10) Pub. No.: US 2025/0045817 A1
(43) Pub. Date: Feb. 6, 2025

(54) COMPUTER-IMPLEMENTED WAREHOUSING PRODUCT TRADING METHOD AND SYSTEM

(71) Applicant: QUICKTRON ROBOTIC INC, PLANO, TX (US)

(72) Inventors: LINFENG LI, Shanghai (CN); XIAOMEI ZHANG, Shanghai (CN); SHUOPENG LIN, Shanghai (CN); SHUNI LI, Shanghai (CN); KIEN YEW LIANG, Shanghai (CN)

(73) Assignee: QUICKTRON ROBOTIC INC, PLANO, TX (US)

(21) Appl. No.: 18/230,154

(22) Filed: Aug. 3, 2023

(51) Int. Cl. G06Q 30/08; G06Q 30/0601

(52) U.S. Cl. CPC G06Q 30/08; G06Q 30/0603

(57) ABSTRACT

A computer-implemented warehousing product trading method and system are provided, wherein the warehousing product trading method includes: in response to a purchase instruction from a customer for one or more interest product packages in a plurality of warehousing product packages for the customer to purchase, displaying to the customer a product standard configuration information set provided by each of the one or more interest product packages; in response to the purchase instruction from the customer for a service catalog provided by each product standard configuration information in the product standard configuration information set, generating and displaying a product instantiation model; and in response to the purchase instruction from the customer for the product instantiation model, generating order information for a warehousing product represented by the product instantiation model.

### TECHNICAL FIELD

The disclosure generally relates to the warehousing field and the computer field, and in particular, to a computer-implemented warehousing product trading method and system.

### BACKGROUND

With vigorous development of the automation industry, a demand for mobile drive units for goods picking, handling and forking has surged in the global market. In a process of providing a warehousing product including a mobile drive unit to a customer based on a traditional project-based sales mode, it is usually necessary to develop a customized solution based on business requirements of the customer, and it often takes a long time for adaptive development and convergence. This process is time-consuming and risky for the customer. In addition, it is difficult for the customer to select a suitable solution based on his real requirements.

### SUMMARY

A computer-implemented warehousing product trading method according to embodiments of the disclosure, including: in response to a purchase instruction from a customer for one or more interest product packages in a plurality of warehousing product packages for the customer to purchase, displaying to the customer a product standard configuration information set provided by each of the one or more interest product packages; in response to the purchase instruction from the customer for a service catalog provided by each product standard configuration information in the product standard configuration information set, generating and displaying a product instantiation model; and in response to the purchase instruction from the customer for the product instantiation model, generating order information for a warehousing product represented by the product instantiation model.

A computer-implemented warehousing product trading system according to embodiments of the disclosure, including: an information display device configured to, in response to a purchase instruction from a customer for one or more interest product packages in a plurality of warehousing product packages for the customer to purchase, display to the customer a product standard configuration information set provided by each of the one or more interest product packages; a model display device configured to, in response to the purchase instruction from the customer for a service catalog provided by each product standard configuration information in the product standard configuration information set, generate and display a product instantiation model; and an order generation device configured to, in response to the purchase instruction from the customer for the product instantiation model, generate order information for a warehousing product represented by the product instantiation model.

### BRIEF DESCRIPTION OF THE DRAWINGS

The disclosure may be better understood from description of specific implementations thereof below in combination with accompanying drawings, wherein:

FIG. 1 illustrates a schematic block diagram of a computer-implemented warehousing product trading system according to embodiments of the disclosure.

FIG. 2 illustrates a schematic flowchart of a computer-implemented warehousing product trading method according to embodiments of the disclosure.

FIG. 3 illustrates a schematic flowchart of a related purchase process and example service catalogs involved in the warehousing product trading system and method shown in FIG. 1 and FIG. 2.

FIG. 4A illustrates a schematic diagram of a bin robot and a handling robot involved in a bin-to-person product package according to embodiments of the disclosure.

FIG. 4B illustrates a schematic diagram of a handling robot involved in a shelf-to-person product package according to embodiments of the disclosure.

FIG. 4C illustrates a schematic diagram of a forklift robot, inventory bins, and a pallet involved in a pallet-to-person product package according to embodiments of the disclosure.

FIG. 4D illustrates a schematic diagram of a handling robot, an inventory holder, and inventory bins/inventory items according to embodiments of the disclosure.

FIG. 5 illustrates a schematic block diagram of an interaction process between the computer-implemented warehousing product trading system according to embodiments of the disclosure and a customer.

FIG. 6 illustrates a schematic diagram of a computer system that can implement the computer-implemented warehousing product trading method and system according to embodiments of the disclosure.

### DETAILED DESCRIPTION

Features and exemplary embodiments of various aspects of the disclosure are described in detail below. In the detailed description below, many specific details are proposed so as to provide comprehensive understanding of the disclosure. However, it is obvious to those skilled in the art that the disclosure may be implemented without some of the specific details. The following description of embodiments is only intended to provide better understanding of the disclosure by illustrating examples of the disclosure. The disclosure is not limited to any specific configurations and algorithms proposed below, but covers any modifications, alternatives, and improvements to elements, components, and algorithms without departing from spirit of the disclosure. In the accompanying drawings and the following description, well-known structures and techniques are not shown in order to avoid unnecessarily obscuring the disclosure.

In view of one or more problems in a process of providing a warehousing product including a mobile drive unit to a customer based on a traditional project-based sales mode, a warehousing product trading scheme, which may be partially implemented by a computer, is proposed, wherein various warehousing products that may be provided to the customer are split into multiple modular components, the modular components are divided into different warehousing product packages for the customer to purchase, a product standard configuration information set provided by each interest product package that the customer want to purchase is displayed, and a product instantiation model is generated and displayed based on a purchase instruction from the customer for a service catalog provided by each product standard configuration information in the product standard configuration information set, so that the customer may intuitively understand, through the product instantiation model, various functions of the warehousing product represented by the product instantiation model. This not only reduces communication costs between sales personnel and the customer, but also improves sales coverage.

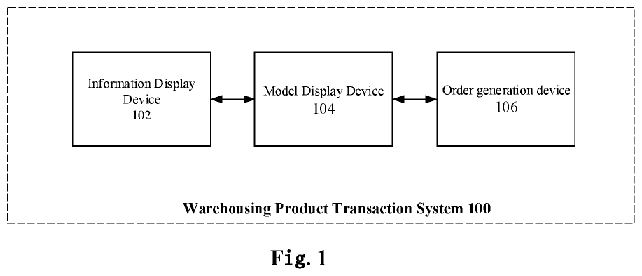

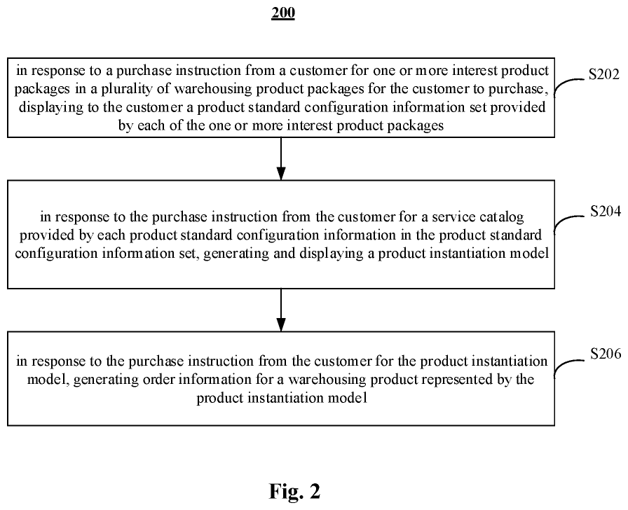

FIG. 1 illustrates a schematic block diagram of a computer-implemented warehousing product trading system 100 according to embodiments of the disclosure. FIG. 2 illustrates a schematic flowchart of a computer-implemented warehousing product trading method 200 according to embodiments of the disclosure. The computer-implemented warehousing product trading system 100 and warehousing product trading method 200 according to embodiments of the disclosure are described in detail below in combination with FIGS. 1-2.

As shown in FIG. 1, the computer-implemented warehousing product trading system 100 according to embodiments of the disclosure includes an information display device 102, a model display device 104, and an order generation device 106. The information display device 102 is configured to, in response to a purchase instruction from a customer for one or more interest product packages in a plurality of warehousing product packages for the customer to purchase, display to the customer a product standard configuration information set provided by each of the one or more interest product packages (that is, implement step S202). The model display device 104 is configured to, in response to the purchase instruction from the customer for a service catalog provided each product standard configuration information in the product standard configuration information set, generate and display a product instantiation model (that is, implement step S204). The order generation device 106 is configured to, in response to the purchase instruction from the customer for the product instantiation model, generate order information for a warehouse product represented by the product instantiation model (i.e., implement step S206).

In the computer-implemented warehousing product trading system 100 and warehousing product trading method 200 according to embodiments of the disclosure, the product standard configuration information set provided by each interest product package may be displayed in response the purchase instruction from the customer for the interest product package, the product instantiation model may be generated and displayed in response to the purchase instruction from the customer for the service catalog provided by each product standard configuration information in the product standard configuration information set, so that the customer may determine whether the warehousing product represented by the product instantiation model matches his business requirements based on the product instantiation model, thereby breaking problems of a long promotion period and a high communication cost of the traditional project based sales mode, making rapid promotion of warehousing products possible. Furthermore, the rapid promotion of warehousing products also accelerates an iterative process of standardization of the warehousing products.

In some embodiments, the model display device 104 may also be configured to generate and display the product instantiation model further in response to personalized demand information input by the customer, and/or generate and display the product instantiation model further in response to the purchase instruction from the customer for a purchase quantity of each interest product package.

In some embodiments, the information display device 102 may also be configured to, in response to a renewing instruction from the customer for the order information, display to the customer the product standard configuration information set provided by each interest product package involved in the warehousing product corresponding to the order information. The model display device 104 may be configured to, in response to the purchase instruction from the customer for the service catalog provided by each product standard configuration information in the product standard configuration information set, generate and display a renewed product instantiation model. The order generation device 106 may be configured to, in response to the purchase instruction from the customer for the renewed warehousing product, generate renewed order information for a renewed warehousing product represented by the renewed product instantiation model.

In some embodiments, the model display device 104 may also be configured to generate and display the renewed product instantiation model further in response to personalized renewing information input by the customer, and/or generate and display the renewed product instantiation model further in response to the purchase instruction from the customer for the purchase quantity of each interest product package involved in the warehousing product corresponding to the order information.

In some embodiments, each of the product instantiation model and the renewed product instantiation model includes an instantiation model of one or more areas in a warehousing space: a human-machine interaction workstation area for human work, a storage area for storing goods, a charging area for automatic charging of mobile drive units, a maintenance area for manual maintenance, and a mobile drive unit operation area. In some examples, the human-machine interaction workstation area may include inbound workstations, outbound workstations, and in-warehouse operations (such as taking inventory, tallying and so on) workstations. The storage area may include racks for storing bins, bins for storing goods, buffer racks for buffering bins, inventory holders for transferring bins and pallets for carrying bins and so on. The charging area may include charging stations applicable for various mobile drive units. The maintenance area may include maintenance zones, spare parts zones, and vehicle testing zones and so on. The mobile drive unit operation area may include mobile drive unit movement channels, mobile drive unit docking points in various function zones, and various mobile drive units. It should be noted that the mobile driving unit may be a bin robot or a handling robot.

In some embodiments, the product standard configuration information set provided by each interest product package includes container information, workstation information, and mobile drive unit information. The order information for the warehousing product represented by the product instantiation model includes a comprehensive quotation and a comprehensive implementation period for the warehousing product represented by the product instantiation model.

It should be appreciated that the computer-implemented warehousing product trading system 100 and warehousing product trading method 200 according to embodiments of the disclosure are proposed based on the following considerations: various warehousing products that may be provided to the customers are split into the multiple modular components, and the multiple modular components are divided into different warehousing product packages, wherein each warehousing product package may include one or more modular components. The customer may assemble the warehousing product matching his business requirements by selecting one or more interest product packages from the multiple warehousing product packages and selecting one or more modular components from each interest product package. Specifically, for any one warehousing product package, each product standard configuration information provided by the warehousing product package may correspond to a modular component in the warehousing product package, and the container information, the workstation information, and the mobile drive unit information in the product standard configuration information set provided by the warehousing product package are used to describe functional characteristics of a container module, a workstation module, and a mobile drive unit module in the warehousing product package. In addition, in some cases, some warehousing product packages may include default modules that cannot be changed by the customers, such as a Warehouse Execution System (WES) module, a robotic arm module, etc.

In some examples, the multiple warehouse product packages for the customer to purchase include a warehousing product package associated with a goods-to-person transfer process or a goods transfer process between specified locations in a warehouse, and the goods-to-person transfer process may be a bin-to-person transfer process, a shelf-to-person transfer process, or a pallet-to-person transfer process. For example, the warehousing product packages for the customer to purchase may include but are not limited to a bin-to-person product package, a shelf-to-person product package, a transit storage product package, and a pallet-to-person product package. The bin-to-person product package is a warehousing product package composed of various modular components that use the bin to implement goods warehousing, outgoing, storage, transportation, and picking. The shelf-to-person product package is a warehousing product package composed of various modular components that use a shelf to implement goods warehousing, outgoing, storage, transportation, and picking. The transit storage product package is a warehousing product package composed of various modular components that use the bin or the shelf to implement goods warehousing, outgoing, storage, and transportation. The pallet-to-person product package is a warehousing product package composed of various modular components that implement circulation and flow of materials throughout an entire production process.

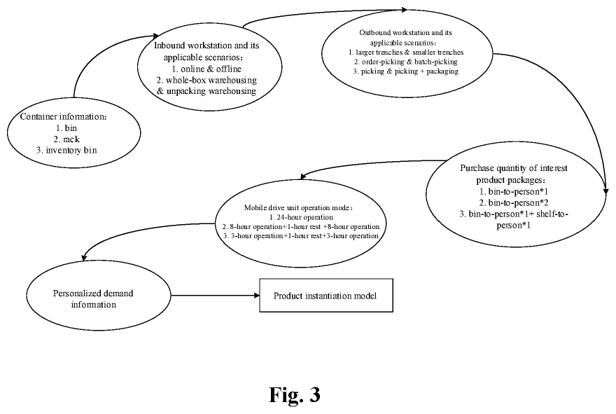

FIG. 3 illustrates a schematic flowchart of a related purchase process and example service catalogs involved in the warehousing product trading system and method shown in FIG. 1 and FIG. 2. As shown in FIG. 3, in some embodiments, the service catalog provided by the container information includes but is not limited to the bin, the rack, and an inventory holder, the service catalog provided by the workstation information includes but is not limited to the inbound workstation and its applicable scenarios (for example, online & offline, whole-box warehousing & unpacking warehousing etc) and the outbound workstation and its applicable scenarios (for example, larger trenches & smaller trenches, order-picking & batch-picking, picking & picking+packaging, etc). The service catalog provided by the mobile drive unit information includes but is not limited to a mobile drive unit carrying capacity, a mobile drive unit purchase quantity, and a mobile drive unit operation mode (for example, 24-hour operation, 8-hour operation+1-hour rest+8-hour operation, and 3-hour operation+1-hour rest+3-hour operation, etc). The customer may select to purchase one or more interest product packages and the purchase quantity for each interest product package may be not limited to one, for example, 1 bin-to-person product package, 2 bin-to-person product packages, or 1 bin-to-person product package plus 2 shelf-to-person product packages. In some examples, the customer may sequentially issue purchase instructions for the service catalog provided by the container information, the service catalog provided by the workstation information, the purchase quantity of interest product packages, and the service catalog provided by the mobile drive unit information, and then input the personalized demand information. The model displaying device 104 may generate and display the product instantiation model in response to the purchase instructions and the personalized demand information from the customer.

In some embodiments, the service catalogs provided by the container information of different warehousing product packages may be different. For example, the service catalog provided by the container information of the bin-to-person product package may include the rack, the bin, and an inventory bin, etc. The service catalog provided by the container information of the shelf-to-person product package may include the rack, etc. The service catalog provided by the container information of the transit storage product package may include an inventory item, the inventory bin, etc. The service catalog provided by the container information of the pallet-to-person product package may include the pallet, etc.

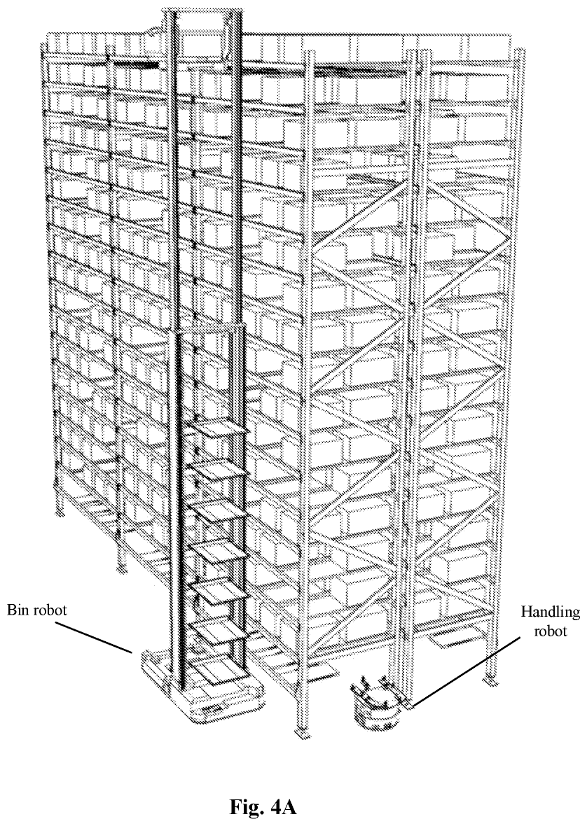

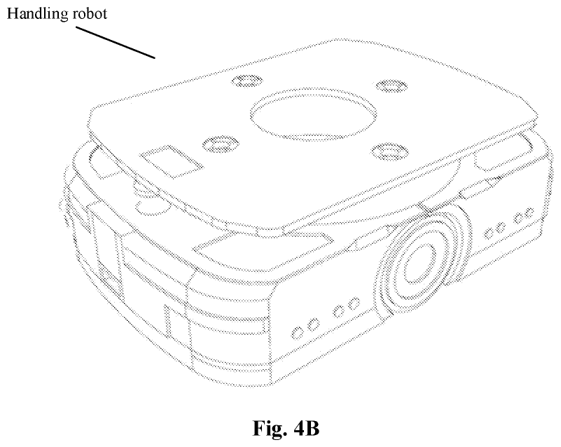

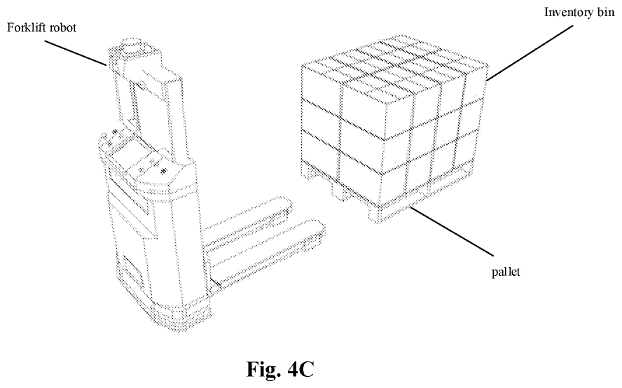

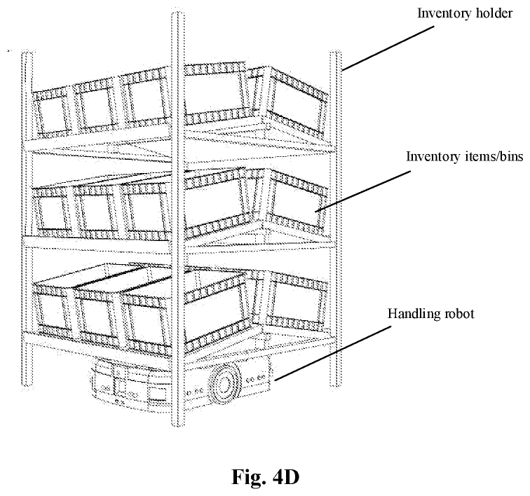

In some embodiments, for any one warehousing product package, in addition to the mobile drive unit carrying capacity, the mobile drive unit purchase quantity, and the mobile drive unit operation mode, the service catalog provided by the mobile drive unit information of the warehousing product package further includes a mobile drive unit type and an auxiliary device that are specific to the warehousing product package and cannot be changed by the customer. For example, for the bin-to-person product package, the mobile drive unit type includes but is not limited to the bin robot and the handling robot, and the auxiliary device includes but is not limited to the charging station and a Robot Control System (RCS). For the shelf-to-person product package, the mobile drive unit type includes but is not limited to the handling robot, and the auxiliary device includes but is not limited to the charging station, the robot control system, etc. For the transit storage product package, the mobile drive unit type includes but is not limited to the bin robot, and the auxiliary device includes but is not limited to the charging station, the robot control system, etc. For the pallet-to-person product package, the mobile drive unit type includes but is not limited to a forklift robot, and the auxiliary device includes but is not limited to the charging station, the robot control system, etc. FIG. 4A illustrates a schematic diagram of the bin robot and the handling robot involved in the bin-to-person product package. FIG. 4B illustrates a schematic diagram of the handling robot involved in the shelf-to-person product package. FIG. 4C illustrates a schematic diagram of the forklift robot, the inventory bin, and the pallet involved in the pallet-to-person product package. It should be appreciated that the bin robot, the handling robot, and the forklift robot are only examples of the mobile drive units, and various warehousing product packages may also involve other mobile drive units. FIG. 4C illustrates a schematic diagram of the handling robot, the inventory holder, and the inventory bins/inventory items.

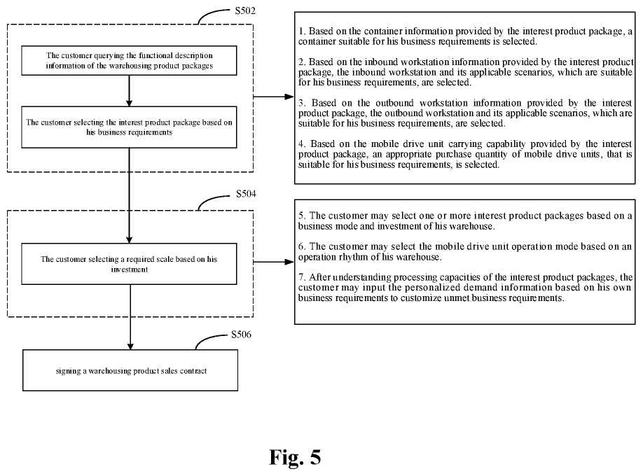

FIG. 5 illustrates a schematic block diagram of an interaction process 500 between the customer and the computer-implemented warehousing product trading system 100 according to embodiments of the disclosure. As shown in FIG. 5, after a product provider publishes the computer-implemented warehousing product trading system 100 on a network, the interaction process 500 between the customer and the computer-implemented warehouse product trading system 100 includes:

S502, the customer queries the functional description information of each warehousing product package for the customer to purchase, and selects the interest product package based on his business requirements:

1. Based on the container information provided by the interest product package, a container suitable for his business requirements is selected. For example, the bin is selected and its applicable commodity size (applicable for a Stock Keeping Unit (SKU) within 600*400*300 mm) is learned.

2. Based on the inbound workstation information provided by the interest product package, the inbound workstation and its applicable scenarios, which are suitable for his business requirements, are selected. For example, based on a manual operation mode currently adopted in his own warehouse and the inbound workstation information provided by the interest product package, the customer selects a corresponding inbound workstation and its applicable scenarios (for example, if the customer needs to quickly transport a large batch of boxes to racks, an online inbound mode and a whole-box inbound workstation may be selected).

3. Based on the outbound workstation information provided by the interest product package, the outbound workstation and its applicable scenarios, which are suitable for his business requirements, are selected. For example, based on an outbound operation mode currently adopted in his warehouse and the outbound workstation information provided by the interest product package, the customer selects a corresponding outbound workstation and its applicable scenarios (for example, the customer has very small goods to be picked according to orders, and checking and packaging are still done manually rather than to be done at the outbound workstation, the customer may select smaller trenches & order-picking & picking).

4. Based on the mobile drive unit carrying capability provided by the interest product package, an appropriate purchase quantity of mobile drive units, that is suitable for his business requirements, is selected. For example, the customer selects a corresponding purchase quantity of mobile drive units based on business throughput of his warehouse.

S504, the customer selects a required scale based on his investment:

5. The customer may select one or more interest product packages based on a business mode and investment of his warehouse. For example, the customer may select the purchase quantity of interest product packages based on his business requirements and the functional description information of the interest product package. For example, assuming that one bin-to-person product package may be assembled into a warehouse of 1200 square meters. If the customer needs to assemble a warehouse of 800 square meters, he only needs to select to purchase one bin-to-person product package. If the customer needs to assemble a warehouse of 6000 square meters, he needs to select to purchase five bin-to-person product packages. Of course, the customer may also select to purchase multiple different interest product packages based on his business requirements. As another example, assuming that one interest product package may be assembled into 4000 order-lines. If the warehouse of the customer may be assembled with 20000 order-lines but his current business only requires 8000 order-lines, the customer may purchase two interest product packages firstly, and then renews one, two, or three interest product packages based on the development of his business, and combine them with the originally purchased interest product package.

6. The customer may select the mobile drive unit operation mode based on an operation rhythm of his warehouse. Specifically, the number of mobile drive units used in different mobile drive unit operation modes will also vary, and corresponding costs will also vary. For example, the warehouse of the customer may allow the mobile drive units to work for 3 hours, rest for 1 hour, and then work for another 3 hours. In this case, the customer may select a corresponding mobile drive unit operation mode, and in this mobile drive unit operation mode, the mobile drive units can have time to charge without the need for continuous operation, which can save the number of mobile drive units to be used by about 20%.

7. After understanding processing capacities of the interest product packages, the customer may input the personalized demand information based on his own business requirements to customize unmet business requirements.

S506, the customer signs a warehousing product sales contract with the computer-implemented warehousing product trading system 100.

A working process of the computer-implemented warehousing product trading system 100 according to embodiments of the disclosure is explained below in combination with a specific example. It is assumed that the customer needs to assemble a warehouse with an area of 12000 square meters, 8000 order-lines and 8-hour operation.

Firstly, the product provider publishes the computer-implemented warehousing product trading system 100 on its online sales platform, and displays to the customer the functional description information of each warehousing product package in the bin-to-person product package, the shelf-to-person product package, the transit storage product package, and the pallet-to-person product package. For example, one bin-to-person product package may be assembled into a warehouse with an area of 2000 square meters, 4000 order-lines and 8-hour operation, while one shelf-to-person product package may be assembled into a warehouse with an area of 1000 square meters, 2000 order-lines and 8-hour operation.

Then, according to his business requirements, the customer may select the bin-to-person product package and the shelf-to-person product packages as the interest product packages, issue the purchase instruction for one bin-to-person product package and one shelf-to-person product package, and then issue the purchase instruction for the service catalog provided by each product standard configuration information in the product standard configuration information set of each interest product package. For example, for the bin-to-person product package, the customer may select the bin (and optionally specify the size of the bin) from the service catalog provided by the container information and issue the purchase instruction; select the inbound workstation from the service catalog provided by the workstation information, select the online inbound mode and the whole-box inbound workstation from a sub-service catalog of the inbound workstation, and issue the purchase instruction; select the outbound workstation from the service catalog provided by the workstation information, select smaller trenches & order-picking & picking from the sub-service catalog of the outbound workstation, and issue the purchase instruction; select the mobile drive unit carrying capacity from the service catalog provided by the mobile drive unit information, select the handling robot with a load capacity of 100 kilograms and the bin robot with a load capacity of 10 kilograms from the sub-service catalog of the mobile drive unit carrying capacity, and issue the purchase instruction; select the mobile drive unit purchase quantity from the service catalog provided by the mobile drive unit information, select 15 bin robots and 50 handling robots from the sub-service catalog of the mobile drive unit purchase quantity, and issue the purchase instruction; select the mobile drive unit operation mode from the service catalog provided by the mobile drive unit information, select the 8-hour operation mode from the sub-service catalog of the mobile drive unit operation mode, and issue the purchase instruction.

Finally, the computer-implemented warehousing product trading system 100 generates the product instantiation model in response to the purchase instructions from the customer for each interest product package and the service catalog provided by each product standard configuration information thereof, and generates the order information for the warehousing product represented by the product instantiation model in response to the purchase instruction from the customer for the product instantiation model.

After assembling the warehouse with an area of 12000 square meters, 8000 order-lines and 8-hour operation, the customer may renew for example, five bin-to-person product packages and one shelf-to-person product package based on his subsequent business requirements. It should be noted that the selection on the service catalogs of the renewed warehousing product package by the customer may be different from the selection on the service catalogs of a corresponding warehousing product package initially purchased. For example, the shelf-to-person product package initially purchased by the customer involves 20 handling robots, and the shelf-to-person product package renewed by the customer may involve any other number of handling robots instead of 20.

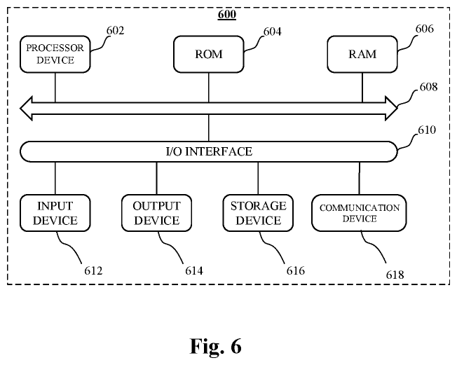

FIG. 6 illustrates a block diagram of a computer system in which the computer-implemented warehousing product trading method and system according to embodiments of the disclosure may be implemented. The computer system 600 suitable for implementing the embodiments of the disclosure will be described below in combination with FIG. 6. It should be appreciated that the computer system shown in FIG. 6 is only an example and should not bring any limitations on functionality and application scopes of the embodiments of the disclosure.

As shown in FIG. 6, the computer system 600 may include a processor device (for example, a central processor, a graphics processor, etc) 602, which may perform various appropriate actions and processes according to programs stored in a Read Only Memory (ROM) 604 or the programs loaded from a storage device 616 into a Random Access Memory (RAM) 606. The RAM 606 also stores various programs and data required for operations of the computer system 600. The processor device 602, the ROM 604, and the RAM 606 are coupled to each other through a bus 608. An Input/output (I/O) interface 610 is also coupled to the bus 608.

Generally, following devices may be coupled to the I/O interface 610: an input device 612 including, for example, a touch screen, a touch pad, a camera, an accelerometer, a gyroscope, a sensor and so on; an output device 614 including, for example, a Liquid Crystal Display (LCD), a speaker, a vibrator, a motor, an electronic governor and so on; a storage device 616 including, for example, a flash card; and a communication device 618. The communication device 618 may allow the computer system 600 to communicate wirelessly or by wire with other devices to exchange data. Although FIG. 6 shows the computer system 600 including various devices, it should be understood that it is not required to implement or include all the devices shown. More or fewer devices may be implemented or provided alternatively. Each box shown in FIG. 6 may represent one or more devices as required.

Particularly, according to the embodiments of the disclosure, the processes described above with reference to the flowcharts may be implemented as a computer software program. For example, the embodiments of the disclosure provide a computer readable storage medium that stores a computer program containing program codes for implementing the warehousing product trading method 200 shown in FIG. 2. In such embodiments, the computer program may be downloaded and installed from a network through the communication device 618, or installed from the storage device 616, or installed from the ROM 604. When the computer program is executed by the processor device 602, the above-mentioned functions defined in the devices according to the embodiments of the disclosure are implemented.

It should be noted that the computer readable medium according to embodiments of the disclosure may be a computer readable signal medium, a computer readable storage medium, or any combination thereof. The computer readable storage medium may be, for example, but not limited to, an electric, magnetic, optical, electromagnetic, infrared, or semiconductor system, apparatus, or device, or any combination thereof. More specific examples of the computer readable storage medium may include but are not limited to: an electrical connection with one or more wires, a portable computer disk, a hard drive, a RAM, a ROM, an erasable programmable read-only memory (EPROM or flash memory), an optical fiber, a portable Compact Disk Read Only Memory (CD-ROM), an optical storage device, a magnetic storage device, or any suitable combination thereof. The computer readable storage medium according to embodiments of the disclosure may be any tangible medium containing or storing a program, which may be used by or in combination with an instruction execution system, apparatus, or device. In addition, the computer readable signal medium according to embodiments of the disclosure may include data signals propagated in a baseband or as part of a carrier wave, which carry the computer readable program codes. The propagated data signals may take various forms, including but not limited to electromagnetic signals, optical signals, or any suitable combination thereof. The computer readable signal medium may also be any computer readable medium other than the computer readable storage medium, which may send, propagate, or transmit programs for use by or in combination with the instruction execution system, apparatus, or device. The program codes contained in the computer readable medium may be transmitted by using any suitable medium, including but not limited to, wires, optical cables, RF (Radio Frequency), etc., or any suitable combination thereof.

The computer program codes for implementing the operations according to embodiments of the disclosure may be written in one or more programming languages or a combination thereof, including object-oriented programming languages such as Java, Smalltalk, C++, and conventional procedural programming languages such as “C” or similar programming languages. The program codes may be completely executed on a user computer, partially executed on the user computer, executed as a standalone software package, partially executed on the user computer and partially executed on a remote computer, or completely executed on a remote computer or server. In cases the remote computer is involved, the remote computer may be connected to the user computer through any type of network, including a Local Area Network (LAN) or a Wide Area Network (WAN), or may be connected to an external computer (for example, via Internet provided by an Internet service provider).

The flowcharts and the block diagrams in the accompany drawings illustrate architectures, functions, and operations of the system, the method, and the computer program product according to various embodiments of the disclosure. Here, each box in a flowchart or block diagram may represent a module, a program segment, or a part of codes that contains one or more executable instructions for implementing specified logical functions. It should be noted that in some alternative implementations, the functions indicated in the boxes may also occur in a different order than those indicated in the accompanying drawings. For example, two consecutive boxes may actually be executed in parallel, and sometimes they may also be executed in an opposite order, depending on the functions involved. It should also be noted that each box in the block diagram and/or the flowchart, as well as a combination of boxes in the block diagram and/or the flowchart, may be implemented by a dedicated hardware based system that performs specified functions or operations, or may be implemented by a combination of dedicated hardware and computer instructions.

The devices described in the embodiments of the disclosure may be implemented by software or hardware. The described devices may also be disposed in the processor, for example, it may described as: a processor, including an information display device, a model display device, and an order generation device. It should be appreciated that names of these devices do not constitute a definition to the devices themselves in certain cases.

The disclosure may be implemented in other specific forms without departing from its spirit and essential features. For example, algorithms described in specific embodiments may be modified, while the system architecture does not deviate from fundamental spirit of the disclosure. Therefore, the current embodiments are considered exemplary rather than limiting in all aspects, and the scope of the disclosure is defined by the accompanying claims rather than the above description, and all changes falling within the scope of the meaning and equivalents of the claims are therefore included in the scope of the disclosure.

What is claimed is:

1. A computer-implemented warehousing product trading method, comprising:
in response to a purchase instruction from a customer for one or more interest product packages in a plurality of warehousing product packages for the customer to purchase, displaying to the customer a product standard configuration information set provided by each of the one or more interest product packages;
in response to the purchase instruction from the customer for a service catalog provided by each product standard configuration information in the product standard configuration information set, generating and displaying a product instantiation model; and
in response to the purchase instruction from the customer for the product instantiation model, generating order information for a warehousing product represented by the product instantiation model.

2. The computer-implemented warehousing product trading method according to claim 1, wherein the product instantiation model is generated and displayed further in response to personalized demand information input by the customer.

3. The computer-implemented warehousing product trading method according to claim 1, wherein the product instantiation model is generated and displayed further in response to the purchase instruction from the customer for a purchase quantity of each of the one or more interest product packages.

4. The computer-implemented warehousing product trading method according to claim 1, wherein the product standard configuration information set comprises container information, workstation information, and mobile drive unit information.

5. The computer-implemented warehousing product trading method according to claim 4, wherein the service catalog provided by the container information comprises a rack, an inventory holder, and a bin.

6. The computer-implemented warehousing product trading method according to claim 4, wherein the service catalog provided by the workstation information comprises an inbound workstation and its applicable scenarios and an outbound workstation and its applicable scenarios.

7. The computer-implemented warehousing product trading method according to claim 4, wherein the service catalog provided by the mobile drive unit information comprises a mobile drive unit carrying capacity, a mobile drive unit purchase quantity, and a mobile drive unit operation mode.

8. The computer-implemented warehousing product trading method according to claim 1, wherein the order information for the warehousing product represented by the product instantiation model comprises a comprehensive quotation and a comprehensive implementation period for the warehousing product represented by the product instantiation model.

9. The computer-implemented warehousing product trading method according to claim 1, wherein the plurality of warehousing product packages for the customer to purchase comprise a warehousing product package associated with a goods-to-person transfer process or a goods transfer process between specified locations in a warehouse.

10. The computer-implemented warehousing product trading method according to claim 1, further comprising:
in response to a renewing instruction from the customer for the order information, displaying to the customer the product standard configuration information set provided by each interest product package involved in the warehousing product corresponding to the order information;
in response to the purchase instruction from the customer for the service catalog provided by each product standard configuration information in the product standard configuration information set, generating and displaying a renewed product instantiation model; and
in response to the purchase instruction from the customer for the renewed product instantiation model, generating renewed order information for a renewed warehousing product represented by the renewed product instantiation model.

11. The computer-implemented warehousing product trading method according to claim 10, wherein the renewed product instantiation model is generated and displayed further in response to personalized renewing information input by the customer.

12. The computer-implemented warehousing product trading method according to claim 10, wherein the renewed product instantiation model is generated and displayed further in response to the purchase instruction from the customer for the purchase quantity of each interest product package involved in the warehousing product corresponding to the order information.

13. The computer-implemented warehousing product trading method according to claim 10, wherein each of the product instantiation model and the renewed product instantiation model comprises an instantiation model of one or more areas in a warehousing space: a human-machine interaction workstation area for human work, a storage area for storing goods, a charging area for automatic charging of mobile drive units, a maintenance area for manual maintenance, and a mobile drive unit operation area.

14. A computer-implemented warehousing product trading system, comprising:
an information display device configured to, in response to a purchase instruction from a customer for one or more interest product packages in a plurality of warehousing product packages for the customer to purchase, display to the customer a product standard configuration information set provided by each of the one or more interest product packages;
a model display device configured to, in response to the purchase instruction from the customer for a service catalog provided by each product standard configuration information in the product standard configuration information set, generate and display a product instantiation model; and
an order generation device configured to, in response to the purchase instruction from the customer for the product instantiation model, generate order information for a warehousing product represented by the product instantiation model.

15. The computer-implemented warehousing product trading system according to claim 14, wherein the model display device is further configured to generate and display the product instantiation model in response to personalized demand information input by the customer.

16. The computer-implemented warehousing product trading system according to claim 14, wherein the product standard configuration information set comprises container information, workstation information, and mobile drive unit information.

17. The computer-implemented warehousing product trading system according to claim 14, wherein:
the information display device is further configured to, in response to a renewing instruction from the customer for the order information, display to the customer the product standard configuration information set provided by each interest product package involved in the warehousing product corresponding to the order information;
the model displaying device is further configured to, in response to the purchase instruction from the customer for the service catalog provided by each product standard configuration information in the product standard configuration information set, generate and display a renewed product instantiation model; and
the order generation device is further configured to, in response to the purchase instruction from the customer for the renewed product instantiation model, generate renewed order information for a renewed warehousing product represented by the renewed product instantiation model.

18. A computer readable storage medium storing computer executable instructions thereon, wherein the computer executable instructions, when executed by a computer, cause the computer to:
in response to a purchase instruction from a customer for one or more interest product packages in a plurality of warehousing product packages for the customer to purchase, display to the customer a product standard configuration information set provided by each of the one or more interest product packages;
in response to the purchase instruction from the customer for a service catalog provided by each product standard configuration information in the product standard configuration information set, generate and display a product instantiation model; and
in response to the purchase instruction from the customer for the product instantiation model, generate order information for a warehousing product represented by the product instantiation model.

19. The computer readable storage medium according to claim 18, wherein the computer executable instructions, when executed by the computer, further cause the computer to:
generate and display the product instantiation model further in response to personalized demand information input by the customer.

20. The computer readable storage medium according to claim 18, wherein the computer executable instructions, when executed by the computer, further cause the computer to:
in response to a renewing instruction from the customer for the order information, display to the customer the product standard configuration information set provided by each interest product package involved in the warehousing product corresponding to the order information;
in response to the purchase instruction from the customer for the service catalog provided by each product standard configuration information in the product standard configuration information set, generate and display a renewed product instantiation model; and
in response to the purchase instruction from the customer for the renewed product instantiation model, generate renewed order information for a renewed warehousing product represented by the renewed product instantiation model.
